(19) United States
(12) Patent Application Publication
(10) Pub. No.: US 2025/0233966 A1
(43) Pub. Date: Jul. 17, 2025

(54) IMAGE CORRECTION APPARATUS, IMAGE CORRECTION METHOD, AND PROGRAM

(71) Applicant: NIPPON TELEGRAPH AND TELEPHONE CORPORATION, Tokyo (JP)

(72) Inventors: Ryo AKIYAMA, Tokyo (JP); Taiki FUKIAGE, Tokyo (JP); Shinya NISHIDA, Tokyo (JP)

(73) Assignee: NIPPON TELEGRAPH AND TELEPHONE CORPORATION, Tokyo (JP)

(21) Appl. No.: 18/705,381

(22) PCT Filed: Oct. 29, 2021
(86) PCT No.: PCT/JP2021/040004

§ 371 Date: Apr. 26, 2024

(51) Int. Cl. H04N 9/31

(52) U.S. Cl. CPC H04N 9/3185; H04N 9/3194

(57) ABSTRACT

Provided is an image correction device and the like, which allow improvement of realistic feeling of colors and texture of a projection portion by correcting a projection image in consideration of brightness of the projection portion with respect to surroundings. Where a projection portion is a range in which a projector projects an image on a projection target, an imaging portion is a range captured by a camera, the imaging portion is larger than the projection portion, and the imaging portion includes the projection portion, the image correction device includes: a projection result estimation unit configured to estimate an image obtained when a projection image is projected onto a projection target, and to obtain a projection result estimation image; a perception distance calculation unit configured to calculate a perception distance that is a perceptual difference in brain representation between a target image and the projection result estimation image; and a projection image update unit configured to update the projection image so as to reduce the perception distance, and to obtain an updated projection image, wherein the projection result estimation image and the target image are images having a size identical to the imaging portion.

### TECHNICAL FIELD

The present invention relates to a technique for correcting a projection image in projection mapping.

### BACKGROUND ART

When an image is projected on a surface of an arbitrary object, an actually displayed image may greatly deviate from an expected appearance due to factors such as ambient light, a reflectance change (texture) of a projection surface, and a dynamic range of a projector.

In Non Patent Literature 1, the projection image can be compensated so as to cancel degradation of the image due to the above factors.

### CITATION LIST

### Non Patent Literature

Non Patent Literature 1: M. Ashdown, T. Okabe, I. Sato and Y. Sato, “Robust Content-Dependent Photometric Projector Compensation”, 2006 Conference on Computer Vision and Pattern Recognition Workshop (CVPRW'06), 2006, pp. 6-6, doi: 10.1109/CVPRW.2006.172.

### SUMMARY OF INVENTION

### Technical Problem

However, since the projector displays an image by adding light to a real object, its range is inevitably bright. Because a projection portion is clearly brighter than surroundings, the reality (realistic feeling) of colors and texture in the range is impaired. In other words, since the conventional compensation is performed only on the basis of the projection image, there is a problem that a difference of an appearance due to comparison with the brightness around the projection portion cannot be fully compensated.

An object of the present invention is to provide an image correction device, an image correction method, and a program, all of which allow improvement of realistic feeling of colors and texture of a projection portion by correcting a projection image in consideration of brightness of the projection portion with respect to surroundings.

### Solution to Problem

In order to solve the above problem, according to one aspect of the present invention, an image correction device, where a projection portion is a range in which a projector projects an image on a projection target, an imaging portion is a range captured by a camera, the imaging portion is larger than the projection portion, and the imaging portion includes the projection portion, the image correction device includes: a projection result estimation unit configured to estimate an image obtained when a projection image is projected onto a projection target, and to obtain a projection result estimation image; a perception distance calculation unit configured to calculate a perception distance that is a perceptual difference in brain representation between a target image and the projection result estimation image; and a projection image update unit configured to update the projection image so as to reduce the perception distance, and to obtain an updated projection image, wherein the projection result estimation image and the target image are images having a size identical to the imaging portion.

### Advantageous Effects of Invention

According to the present invention, it is possible to provide an effect of improving realistic feeling of colors and texture of a projection portion.

### BRIEF DESCRIPTION OF DRAWINGS

FIG. 1 is a functional block diagram of an image correction device according to a first embodiment.

FIG. 2 shows an example of a processing flow of the image correction device according to the first embodiment.

FIG. 3 is a view for illustration of a projection portion, an imaging portion, and a non-control portion.

FIG. 4 is a diagram illustrating a configuration example of a computer to which the present method is applied.

### DESCRIPTION OF EMBODIMENTS

Hereinafter, an embodiment of the present invention will be described. Note that, in the drawings to be used in the description below, components having the same functions or steps for performing the same processing will be denoted by the same reference numerals, and description thereof will not be repeated. In the following description, processing to be performed for each element of a vector or a matrix is applied to all elements of the vector or the matrix, unless otherwise specified.

### First Embodiment

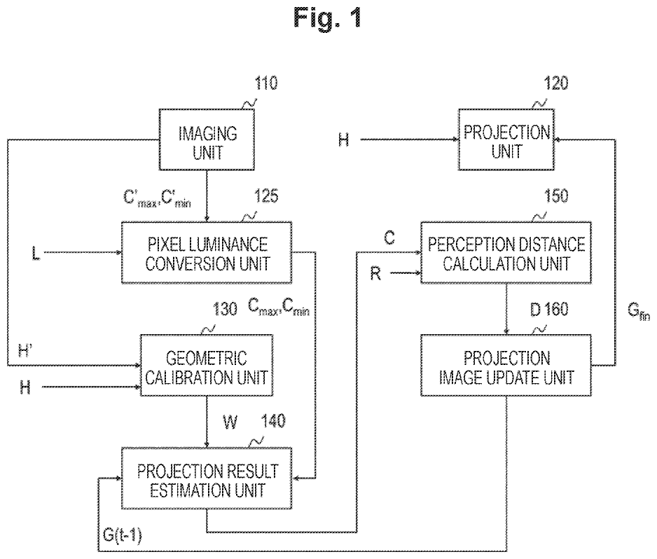

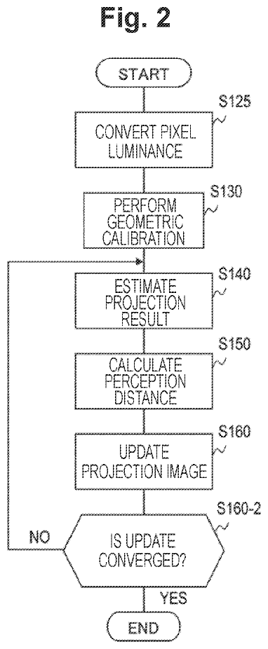

FIG. 1 is a functional block diagram of an image correction device according to a first embodiment, and FIG. 2 shows an example of a processing flow thereof.

The image correction device includes an imaging unit 110, a projection unit 120, a pixel luminance conversion unit 125, a geometric calibration unit 130, a projection result estimation unit 140, a perception distance calculation unit 150, and a projection image update unit 160.

The image correction device uses a target image R as an input, corrects a projection image G(t) in consideration of brightness of a projection portion with respect to surroundings, and projects a corrected projection image G_{fin} onto a projection target via the projection unit 120. Note that t represents a number of update times of the projection image G(t) by the projection image update unit 160, and G(0) represents an initial value of the projection image.

In the present embodiment, a case where a grayscale image is handled will be described as an example. In a case where a color image is handled, each of RGB is processed independently. All images in the following description represent a series of pixel values. In a grayscale image, each pixel has a brightness value, and in a color image, each pixel has an RGB value.

The image correction device is a special device configured such that a special program is loaded into a known or dedicated computer including, for example, a central processing unit (CPU), a main storage device (random access memory (RAM)), and the like. The image correction device executes each of pieces of processing under control of the central processing unit, for example. Data input into the image correction device and data obtained in each of the pieces of processing are stored in, for example, the main storage device, and the data stored in the main storage device is read to the central processing unit as necessary and used for other processing. At least some of the processing units of the image correction device may be configured by hardware such as an integrated circuit. Each of the storage units included in the image correction device can be configured by, for example, a main storage device such as a random access memory (RAM) or middleware such as a relational database and a key value store. Note, however, that each of the storage units is not necessarily provided inside the image correction device. Each of the storage units may be configured by an auxiliary storage device including a hard disk, an optical disk, or a semiconductor memory device such as a flash memory, and may be provided outside the image correction device.

Each of the units will be described below.

### <Imaging Unit 110 and Projection Unit 120>

The imaging unit 110 includes a camera, and the projection unit 120 includes a projector.

The image correction device projects a Gray code pattern H onto the projection target via the projection unit 120, captures the projected Gray code pattern by the imaging unit 110, and obtains a Gray code pattern projection result H′ (image for geometric calibration). For example, an image for geometric calibration is obtained by the method of Reference Literature 1.
(Reference Literature 1) S. Inokuchi, K. Sato, and F. Matsuda, “Range-imaging system for 3-D object recognition”, in Proceedings of International Conference on Pattern Recognition, 1984, pp. 806-808.

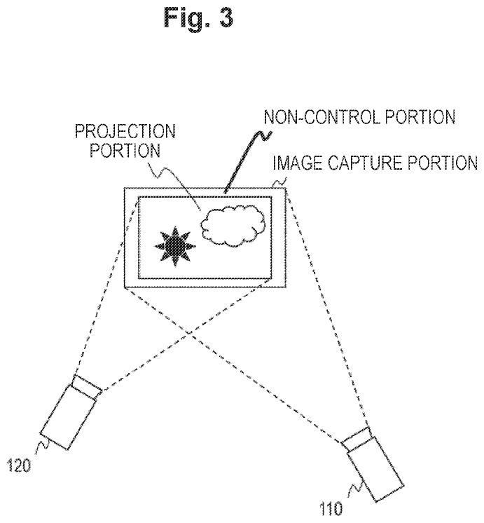

Here, a range in which the projector of the projection unit 120 projects an image onto the projection target is referred to as a projection portion, and a range captured by the camera of the imaging unit 110 is referred to as an imaging portion (see FIG. 3). The projector and the camera are set such that the imaging portion is larger than the projection portion and the imaging portion includes the projection portion. Due to the image correction based on human visual characteristics, even if the projection target is physically brighter than the surroundings due to the projection, it is perceptually felt that the appearance of the object itself has changed. In the present embodiment, optimization is performed including a periphery of the projection portion by setting the imaging portion to be larger than the projection portion. Here, a portion included in the imaging portion but not included in the projection portion is also referred to as a non-control portion. The imaging portion may be set according to a size of the periphery to be considered.

In addition, the image correction device obtains a captured image C′ₘₐₓ by capturing, by the imaging unit 110, a projection target when white projection of a maximum output of the projector of the projection unit 120 is performed, and obtains a captured image C′ₘᵢₙ by capturing, by the imaging unit 110, a projection target when projection of a minimum output of the projector of the projection unit 120 is performed.

In addition, a luminance value L at an arbitrary position of the projection target when white projection of the maximum output of the projector of the projection unit 120 is performed is measured using a luminance measuring device that is not illustrated, and used as an input of the image correction device.

### <Pixel Luminance Conversion Unit 125>

Input: captured images C′ₘₐₓ and C′ₘᵢₙ, and luminance value L
Output: maximum output image Cₘₐₓ and minimum output image Cₘᵢₙ

The pixel luminance conversion unit 125 calculates a ratio between the luminance value L and a camera pixel value v at the same position as the arbitrary position at which the luminance value L is measured, to obtain a scaling coefficient s=L/v for converting a pixel value into a luminance value. The camera pixel value v is a camera pixel value at the same position as the arbitrary position at which the luminance value L is measured in the captured image C′ₘₐₓ.

The pixel luminance conversion unit 125 scales the captured images C′ₘₐₓ and C′ₘᵢₙ by the scaling coefficient s to obtain a maximum output image Cₘₐₓ (=sC′ₘₐₓ) and a minimum output image Cₘᵢₙ (=sC′ₘᵢₙ) of a luminance scale (S125).

### <Geometric Calibration Unit 130>

Input: Gray code pattern H, Gray code pattern projection result (image for geometric calibration) H′
Output: conversion function W

The geometric calibration unit 130 calculates geometric mapping between the camera and the projector. Specifically, using the Gray code pattern H and the Gray code pattern projection result (image for geometric calibration) H′, the geometric calibration unit 130 obtains a conversion function W from coordinates (projector coordinate system) of the Gray code pattern H (projection image output from the projector of the projection unit 120) to coordinates of the Gray code pattern projection result H′ (image for geometric calibration taken by the camera of imaging unit 110) (coordinates when the projected image is reflected on the projection target surface and captured as a camera image). For example, the conversion function W is obtained by decoding the gray code by the method described in Reference Literature 1 (S130). Note that the Gray code pattern H is image data of a size of resolution of the projector to be projected on the projection portion, and the Gray code pattern projection result is image data of a size of resolution of the camera corresponding to the imaging portion.

### <Projection Result Estimation Unit 140>

Input: conversion function W, maximum output image Cₘₐₓ, minimum output image Cₘᵢₙ, projection image G(t−1)
Output: projection result estimation image C

The projection result estimation unit 140 estimates an image (projection result image) obtained when the projection image G(t−1) is projected onto the projection target (S140), and obtains a projection result estimation image C.

For example, the projection result estimation unit 140 first obtains, using the conversion function W, a projection result estimation image G′(t−1)=W(G(t−1)) that is geometrically converted into the camera coordinate system from an initial value G(0) of the projection image or the projection image G(t−1) updated by the projection image update unit 160 (S140). Note that the projection image G(t−1) is image data of a size corresponding to the projection portion, and the projection result estimation image G′(t−1) is image data of a size corresponding to the imaging portion.

Next, the projection result estimation unit 140 obtains the projection result estimation image C by converting into a luminance value reflected from the projection target by the following equation.

$$C = ( {C}_{max} - {C}_{min} ) {G}^{′} ( t - 1 ) + {C}_{min}$$

Note that this calculation is calculation of geometrically corresponding pixel values, and is scalar calculation. In addition, the images Cₘₐₓ, Cₘᵢₙ, and C are image data of a size corresponding to the imaging portion.

### <Perception Distance Calculation Unit 150>

Input: projection result estimation image C, target image R
Output: perception distance D(R,C)

The perception distance calculation unit 150 calculates a perception distance D(R,C) that is a perceptual difference in the brain representation between the target image R and the projection result estimation image C (S150). For example, the perception distance calculation unit 150 inputs the target image R and the projection result estimation image C to a visual model (model of brain representation), and calculates a distance (perception distance) D(R,C) in the brain representation of each image. The target image R is an apparent target image after projection, and is image data of a size corresponding to the imaging portion. For example, the target image R is obtained by image-processing-wise correcting the camera image obtained by imaging the projection target before projection to a desired appearance, and the like, and the positions of the pixels of the target image R and the camera image completely correspond to each other. Similarly to the projection result estimation image C, the target image R is an image whose pixel value is the luminance scale. As the model of the brain representation, for example, Normalized Laplacian Pyramid Distance (NLPD), which is a low-order visual information processing model in Reference Literature 2, can be used, and the perception distance is calculated using this visual information processing model.
(Reference Literature 2) Laparra et al., “Perceptually Optimized Image Rendering”, In JOSA, 2017

### <Projection Image Update Unit 160>

Input: perception distance D
Output: projection image G(t) or optimized projection image G_{fin}

The projection image update unit 160 updates the projection image G(t−1) so as to reduce the value of the perception distance D, and obtains the updated projection image G(t). For example, based on a gradient of the perception distance D for each pixel value of the projection image G(t−1), each pixel value of the projection image G(t−1) is updated so that the perception distance D decreases (S160). Various conventional techniques can be used as a method of updating the projection image G(t). For example, the update method in Reference Literature 3 (ADAM) can be used.
(Reference Literature 3) Diederik P. Kingma et al., “ADAM: A Method for Stochastic Optimization”, In ICLR, 2015.

If the projection image G(t−1) is simply updated so as to reduce the “color distance” between the projection image G(t) and the target image R, the reality (realistic feeling) of the colors and texture in the range is impaired due to the projection portion that is clearly brighter than the surroundings. However, the non-control portion around the projection portion cannot be controlled. Therefore, in the present embodiment, the projection image G(t−1) is updated in consideration of the non-control portion so as to reduce the perception distance D. By performing image correction based on human visual characteristics, the perception distance decreases even if the actual “color distance” increases, and the reality (realistic feeling) is improved.

The projection image update unit 160 repeats steps S140 to S160 until the update of projection image G(t) converges (NO in step S160-2). When the update of the projection image G(t) converges (YES in S160-2), the projection image update unit 160 stops the update and outputs the projection image G(t) at that time as an optimum value (optimized projection image G_{fin}). The projection image G_{fin} is projected onto the projection target via the projection unit 120.

For example, in a case where the perception distance D does not decrease for a predetermined number of update times (for example, 20 times) or reaches a predetermined maximum number of update times (for example, 500 times), it is determined that the update of the projection image G(t) has converged.

### <Effects>

With the above configuration, it is possible to provide an effect of improving realistic feeling of colors and texture of a projection portion by projecting the optimized projection image onto the projection target. Furthermore, it is possible to edit the appearance of the projection target naturally. In the present embodiment, the projection image is optimized on a pixel-by-pixel basis such that a series of flows from the projection image to the brain representation through interaction with the surrounding environment is simulated, the “perceptual difference” between a target image and an actual projection result in the brain representation is calculated, and the “perceptual difference” as a loss is minimized. With such a configuration, by performing the image correction based on human visual characteristics, even if the target is physically brighter than the surroundings due to the projection, it is perceptually felt that the appearance of the object itself has changed.

### <Modification>

In the present embodiment, the image correction device includes the imaging unit 110 and the projection unit 120, but may not include the imaging unit 110 and the projection unit 120, and, instead, may include the pixel luminance conversion unit 125, the geometric calibration unit 130, the projection result estimation unit 140, the perception distance calculation unit 150, and the projection image update unit 160. In this case, the image correction device receives the maximum output image Cₘₐₓ and the minimum output image Cₘᵢₙ, the Gray code pattern H, and the Gray code pattern projection result H′ in addition to the target image R, corrects the projection image G(t) in consideration of the brightness of the projection portion with respect to the periphery, and outputs the corrected projection image G_{fin} to the projection unit 120.

### <Other Modifications>

The present invention is not limited to the foregoing embodiment and the modification. For example, various kinds of processing described above may be executed not only in time series in accordance with the description but also in parallel or individually in accordance with processing abilities of the devices that execute the processes or as necessary. Further, modifications can be made as needed within the gist of the present invention.

### <Program and Recording Medium>

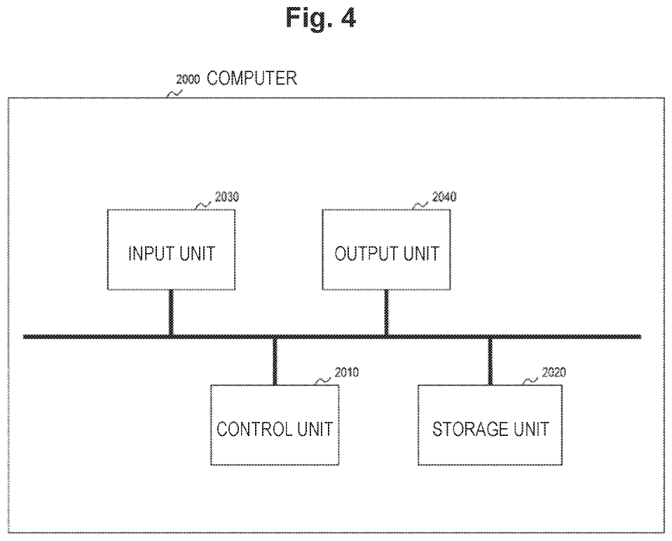

Various kinds of processing described above can be carried out by causing a storage unit 2020 of a computer illustrated in FIG. 4 to load a program for executing each step of the method described above and causing a control unit 2010, an input unit 2030, an output unit 2040, and the like, to operate.

The program in which the processing content is described can be recorded in a computer-readable recording medium. The computer-readable recording medium may be, for example, any recording medium such as a magnetic recording device, an optical disc, a magneto-optical recording medium, or a semiconductor memory.

Moreover, the program is distributed by, for example, selling, transferring, or renting a portable recording medium such as a DVD or a CD-ROM in which the program is recorded. Furthermore, a configuration may also be employed in which the program is stored in a storage device of a server computer and the program is distributed by transferring the program from the server computer to other computers via a network.

For example, a computer that executes such a program first temporarily stores a program recorded in a portable recording medium or a program transferred from the server computer in a storage device of the own computer. Then, when executing processing, the computer reads the program stored in the recording medium of the own computer and executes processing according to the read program. Moreover, as another mode of the program, the computer may read the program directly from the portable recording medium and execute processing in accordance with the program, or alternatively, the computer may sequentially execute processing in accordance with a received program every time the program is transferred from a server computer to the computer. Furthermore, the above-described processing may be executed by a so-called application service provider (ASP) type service that implements a processing function only by an execution instruction and result acquisition without transferring the program from the server computer to the computer. Note that the program in the present embodiment includes information that is used for processing by an electronic computer and is equivalent to the program (data or the like that is not a direct command to the computer but has property that defines processing by the computer).

Although the present device is configured by executing a predetermined program on a computer in the present embodiment, at least a part of the processing content may be implemented by hardware.

1. An image correction system, the image correction system comprising:
estimating an image obtained when a projection image is projected onto a projection target, and to obtain a projection result estimation image;
calculating a perception distance that is a perceptual difference in brain representation between a target image and the projection result estimation image; and
updating the projection image so as to reduce the perception distance, and to obtain an updated projection image, wherein
q the projection result estimation image and the target image are images having a size identical to the imaging portion.

2. An image correction method, the image correction method comprising:
a projection result estimation step for estimating an image obtained when a projection image is projected onto a projection target, and obtaining a projection result estimation image;
a perception distance calculation step for calculating a perception distance that is a perceptual difference in brain representation between a target image and the projection result estimation image; and
a projection image update step for updating the projection image so as to reduce the perception distance, and obtaining an updated projection image, wherein
the projection result estimation image and the target image are images having a size identical to the imaging portion.

3. (canceled)

4. A computer-readable non-transitory recording medium storing computer-executable program instructions that when executed by a processor cause a computer to execute a program generation method comprising:
estimating an image obtained when a projection image is projected onto a projection target, and to obtain a projection result estimation image;
calculating a perception distance that is a perceptual difference in brain representation between a target image and the projection result estimation image; and
updating the projection image so as to reduce the perception distance, and to obtain an updated projection image, wherein
the projection result estimation image and the target image are images having a size identical to the imaging portion.

5. The image correction system of claim 1, wherein the projection result estimation image has identical projection colors and textures.
